(19) United States
(12) Patent Application Publication
(10) Pub. No.: US 2015/0264674 A1
(43) Pub. Date: Sep. 17, 2015

(54) Radio-transmission system and a radio-transmission method with multiple-channel access

(71) Applicant: Rohde & Schwarz GmbH & Co. KG, Munich (DE)

(72) Inventors: Hagen Pfeifer, Munich (DE); Christian Obersteiner, Munich (DE)

(21) Appl. No.: 14/660,390

(22) Filed: Mar. 17, 2015

(30) Foreign Application Priority Data
Mar. 17, 2014 (DE) 10 2014 204 886.9

(51) Int. Cl. H04W 72/04; H04W 74/08

(52) U.S. Cl. CPC H04W 72/044; H04W 74/0816

(57) ABSTRACT

The invention relates to a radio-transmission system with multiple-channel access for the transmission of data packets of different data sources via a communications channel. The system has a channel-observation unit configured for observation of the channel loading of the communications channel, an evaluation unit configured for evaluation of the observed channel loading, a channel allocation unit configured for allocation of a sub-channel to a data source on the basis of the evaluated channel loading and a channel control unit configured for the time control of the sub-channel allocation. The invention further relates to a radio-transmission method.

### PRIORITY

This application claims priority of German patent application DE 10 2014 204 886.9 filed on Mar. 17, 2014.

### FIELD OF THE INVENTION

The invention relates to a radio-transmission system and a radio-transmission method with multiple-channel access for the transmission of data packets from different data sources via a communications channel.

### BACKGROUND OF THE INVENTION

In radio-transmission technology, multiple-access schemes on a communications channel are particularly suitable for allowing several participants, which are generally disposed spatially remote from one another, the simultaneous and shared use of a high-frequency transmission channel for a plurality of different datastreams. The participants are designated in the following as data sources.

The time multiplex method (abbreviation TDMA) or the frequency multiplex method (abbreviation FTMA) or the code multiplex method (abbreviation CDMA) are especially known as Multiple Access Schemes in this context. In principle, the communications channel is subdivided here into a plurality of sub-channels in order to allow the largest possible number of different data sources a simultaneous and shared transmission of data packets, also designated as payload data, via this communications channel. Accordingly, the communications channel is subdivided, for example, into timeslots, frequency slots or different codings, wherein one sub-channel is allocated exclusively to each data source. The subdivision of the channel is implemented through independent application by the data sources themselves to a sub-channel or is organised by a central element in the radio-transmission system.

To avoid transmission errors in the multiple access schemes, collision identification mechanisms are used, so that, in particular, no error transmission of data packets occurs in the event of an erroneous allocation of a sub-channel to two different data sources. The data packets of the individual data sources can be prioritised differently, so that, in the case of a given urgency, a sub-channel is allocated preferentially to a data source with high prioritisation, in front of a data source of relatively lower priority.

The allocation of each sub-channel is implemented, for example, through a static sub-channel allocation. In this context, each data source receives a rigidly defined access to a sub-channel according to a specified agreement in order to transmit data within the radio-transmission system, for example, a fixed time slot in a TDMA transmission system or a fixed frequency in an FTMA transmission system. A static channel-access method of this kind allows collision-free transmissions. Furthermore, the channel capacity is predictable, so that it is always known how loaded the radio-transmission system is.

The disadvantage with a static sub-channel allocation is the lack of flexibility with regard to influencing unpredictable channel changes. Such changes of channel are, in particular, a matching of the topology of the radio-transmission system, changed environmental influences or a sudden expansion in data sources and/or data volumes.

For this reason, a dynamic slot allocation (abbreviation DSA) is increasingly used nowadays. Through the use of prioritisations for data sources, signal-quality analyses, carrier testing (Carrier Sense Multiple Access, abbreviation CSMA) within the DSA, the dynamic allocation of a sub-channel for the respective data source is specified spontaneously on the basis of environmental influences, the communications volume on the communications channel and the network topology at the time of the data transmission.

For example, US 2013/0100942 A1 describes a DSA algorithm for mobile, spontaneous networking (Mobile Ad-Hoc Networks, abbreviation MANET) of a TDMA radio-transmission system. In this context, the dynamic allocation of the sub-channels is implemented on the basis of a subdivision of the data sources according to geographical circumstances in order to improve the quality of service (abbreviation QoS) and in this manner to guarantee an improved transmission of data packets.

With the known DSA methods, it is possible for several data sources to apply simultaneously to one sub-channel to transmit data packets. In this context, the application takes place on the communications channel itself, which is also designated as In-Bound Signalling. For this purpose, a packet with header data is placed in front of the transmission of data packets or transmitted together in the first data packet. The header data comprise additional information, especially address information of the transmitter and the receiver and optionally the number and size of the data packets to be transmitted.

It is problematic that header data must be transmitted in order to allow an unambiguous identification of the data packets and to avoid collisions. For each data source, at least one header data packet must be provided, so that the ratio of header data to payload data is impaired. In an unfavourable case, for an application to a sub-channel for transmission of a single data packet, precisely one header data packet is transmitted. If the application is successful at the first attempt, a sub-channel is allocated to the data source. In this case, the ratio between payload data and header data is 1:1, so that 50% of the channel capacity of this sub-channel is required for the header data. This ratio is further impaired with every unsuccessful application for a sub-channel of this data source.

An efficient exploitation of the communications channel is not possible with such ratios of header data to payload data. The channel capacity relative to the data packets is accordingly enormously impaired.

Accordingly, one object of the invention among others is to improve further the efficiency of an existing communications channel and to improve the ratio of header data to payload data. In this context, the existing mechanisms for sub-channel allocation are not to be changed, so that collision-identification mechanisms and prioritisations of data sources can still be used successfully.

### SUMMARY OF THE INVENTION

According to one aspect of the invention a radio-transmission system with multiple channel access for the transmission of data packets from different data sources via one communications channel. The system provides a channel observation unit which is configured for observation of the channel loading of the communications channel is proposed. The system provides an evaluation unit which is configured for evaluation of the observed channel loading. The system further provides a channel allocation unit which is configured for allocation of a sub-channel to a data source on the basis of the evaluated channel loading. Finally, the system provides a channel control unit which is configured for the time control of the sub-channel allocation.

The radio-transmission system is, in particular but not exclusively, a TDMA, CDMA and/or FDMA radio system. In particular, the radio-transmission system is used for mobile data transmission within a mobile-radio network, for example, GSM, LTE, UMTS and/or MANET.

Through the observed information about the channel loading of the communications channel from the channel observation unit which is in turn evaluated in the evaluation unit, situations relating to the channel loading can be identified in an improved manner and, especially, an interruption of already established channel allocations of individual data sources can be prevented.

An improvement in the heuristics for future channel loadings can be achieved by the channel observation unit and the evaluation unit, since assumptions and inferences about the channel loading and the future use of the communications channel by the different data sources can be predicted in an improved manner through analytic observation of the channel loading. After the observation and evaluation of the channel loading, a weighting is carried out in order to determine a cognitive behaviour of the channel.

In this context, a reduction of the header data can be achieved on the basis of the knowledge about the channel loading and the exploitation of the channel within the radio-transmission system. Accordingly, the ratio of header data to payload data is substantially improved, thereby utilising the channel capacity with regard to the transmission of payload data in a substantially more efficient manner.

On the basis of this radio-transmission system according to another aspect of the invention, the reservation of a sub-channel is implemented not only on the basis of the current channel circumstances, but also on the basis of the observed, past channel circumstances.

If a data packet is transmitted, the allocation unit decides which sub-channel should preferably be allocated on the basis of the past of the transmission. The goal is to allocate as many sub-channels as possible and to minimise the number of header data.

The observation unit is preferably configured to observe the channel loading for at least one pre-defined time period, wherein an allocation of a data source to a sub-channel is only implemented after the expiry of the pre-defined time period. Accordingly, it is advantageously possible for data sources to which a sub-channel in the communications channel has not yet been allocated to wait for a pre-defined time period in order to observe and evaluate the channel, evaluate an existing channel situation, identify an established channel allocation and to achieve an efficient channel allocation without the increased use of header data required to apply for a sub-channel.

In this manner, the probability of an error allocation or the increase of the header data rate is reduced. The pre-defined time period is preferably adjustable as a parameter in the channel observation unit. Accordingly, the observation time period can be adapted arbitrarily to an existing system topology or a momentary communications volume.

The channel observation unit, also designated as slot monitor, is preferably a passive unit in the radio-transmission system and reroutes this information to the passive evaluation unit.

After the evaluation of the channel loading, the evaluation unit supplies the evaluated channel loading to an allocation unit in the media access control (abbreviation MAC) by means of a programming interface (Application Programming Interface, abbreviation API). In this context, the channel observation unit and also the evaluation unit do not themselves allocate any sub-channels but rather collect and evaluate the channel loading in order to suggest a reservation of a favourable and effective channel allocation. By means of the channel observation unit, a conservative and aggressive channel allocation can be prevented.

In particular, the channel observation unit is an information collection unit and not a decision unit. The channel evaluation unit is, particularly, an information evaluation unit and not a decision unit. Especially in the case of a complete loading of all sub-channels, the information from the channel observation unit is used in order to prevent an aggressive compulsory allocation of a sub-channel and not to disturb an established transmission of data packets from another data source.

The channel allocation unit (Slot Allocator) allocates a sub-channel to a data source on the basis of the evaluated channel loading. On the basis of the information from the evaluation unit, the channel allocation for the data source takes place on one or more sub-channels for an arbitrarily long or short period.

In a preferred embodiment, the evaluation unit is configured to evaluate the observed channel loading with regard to potentially free sub-channels. The allocation of sub-channels which are already in use or should preferably be used for other data sources is advantageously prevented. In consequence, a transmission without additional header data is made possible, so that the channel capacity is used more efficiently for the transmission of payload data.

In a preferred embodiment, the evaluation unit is configured to identify a quasi-continuous data transmission on one of the sub-channels, wherein this sub-channel is evaluated by the evaluation unit as loaded. The identification of an established quasi-continuous data transmission (Data Streaming) is especially advantageous in order not to release the sub-channel of the data source of the datastream and allocate it to another data source, since a higher volume of header data would be unavoidable as a result.

In one preferred embodiment, the evaluation unit is configured to identify a data source with at least two already allocated sub-channels, wherein the allocation unit is prompted by the evaluation unit to release at least one of these allocated sub-channels of this data source. This embodiment advantageously means that a new data source is not rejected or does not remain in a waiting mode (idle mode), but transmits its data packets on an exclusively released sub-channel from a data source which has been allocated a plurality of sub-channels in the past. Accordingly, both data sources can immediately transmit data packets.

In a preferred embodiment, the evaluation unit is configured to identify at least two data sources with at least two already allocated sub-channels, wherein the allocation unit is prompted by the evaluation unit to release at least one of the allocated sub-channels from one of the data sources. This prompting of the allocation unit by the evaluation unit occurs, in particular, by a random mechanism (Dice Rolling). Furthermore, the prompting can also be achieved through the number of already allocated channels and/or the number of data packets to be transmitted. In this manner, one sub-channel is released in order to allow a new data source to transmit data packets within the radio-transmission system.

In a preferred embodiment, the evaluation unit is configured to identify the dedicated use of a sub-channel for a data source, wherein this sub-channel is identified as loaded and, especially, need not be always reallocated to this data source by the allocation unit. A behaviour of a data source is analysed by the observation unit. If the observation unit determines that a data source always transmits a small number of data packets, a constant allocation of the sub-channel to the data source would have to be implemented within the system. The new allocation of the sub-channel by the observation unit can be advantageously avoided. Accordingly, the sub-channel is reserved for this data source to transmit the small number of data packets without the data source always needing to apply for a sub-channel. This avoids an increased occurrence of header data. The ratio of payload data to header data is therefore improved, and the channel capacity available is exploited more efficiently.

By preference, the evaluation unit evaluates the number of data packets per data source per time. Accordingly, information from the past is analysed in order to make heuristic statements about which data source will need which sub-channel for how long. In particular, data sources which transmit quasi-continuous data packets or which transmit a large number of small data packets are advantageously identified, so that the channel allocation can be implemented more efficiently. In particular, in this context, it can be evaluated whether a data source especially prefers a specific channel loading and/or whether it is advantageous to keep a sub-channel exclusively reserved for one data source. Such reservations are then taken into consideration by the observation and evaluation unit and made available as information for the channel allocation unit. The channel control unit will preferably not allocate such sub-channels to other data sources.

In particular, the number of allocated sub-channels per data source per time is evaluated. This ensures that the data volume which is to be transmitted from a data source is registered. If this data source applies again, the evaluation unit tries to reserve a large number of sub-channels for this data source in order to allow the speediest possible transmission of the large data volumes.

To prevent a constant reallocation of a sub-channel to the same data source, a channel is preferably constantly allocated to a data source, if the channel capacity allows this. A constant application for this sub-channel with the transmission of header data by the data source can be prevented in this context.

Through the heuristic analysis of the data volume in the past, the data volume occurring in the future can be predicted. This information is used to allocate the sub-channels efficiently. In particular, the evaluation unit evaluates the total number of allocated sub-channels.

In a preferred embodiment, the evaluation unit is adapted to an existing typology and the specific radio-transmission system. In this context, parameters such as sampling rate, resolution, quantisation and averaging should especially be used. This allows an ideal transmission and efficient transmission across the communications channel.

Furthermore, the radio-transmission system provides a collision management system and a prioritisation system. This ensures that the observation and evaluation system does not put the existing collision management and prioritisation management mechanisms out of action. If a data source must transmit data with a high urgency, the prioritisation takes place independently of the observation and evaluation unit.

According to still another aspect of the invention, a radio-transmission method with multiple channel access is also provided for the transmission of data packets via a communications channel. The radio-transmission method comprises the method steps: observation of a channel loading of the communications channel; evaluation of the observed channel loading; allocation of a sub-channel dependent upon the evaluated channel loading; and control of the channel loading on the basis of the allocated sub-channels.

### BRIEF DESCRIPTION OF THE DRAWINGS

In the following, the invention, further exemplary embodiments and advantages of the invention are explained in greater detail with reference to the Figures. of the drawings, wherein the drawings merely describe exemplary embodiments of the invention by way of example only. Identical components in the drawings are provided with identical reference numbers. The figures of the drawings show:

FIG. 1 a first exemplary embodiment of a radio-transmission system according to the invention;

FIG. 2 the first channel loading according to the invention, based on the channel loading in the past evaluated by the evaluation unit;

FIG. 3 an alternative channel loading according to the invention to that shown in FIG. 2, based on the channel loading in the past evaluated by the evaluation unit;

FIG. 4 an alternative channel loading according to the invention to those shown in FIGS. 2 and 3, based on the channel loading in the past evaluated by the evaluation unit;

FIG. 5 a decision diagram according to the invention for the observation and evaluation unit;

FIG. 6 an alternative channel loading according to the invention to those shown in FIGS. 2, 3 and 4, based on the channel loading in the past evaluated by the evaluation unit;

FIG. 7 an evaluation result according to the invention, based on the channel loading in the past evaluated by the evaluation unit.

### DETAILED DESCRIPTION OF THE DRAWINGS

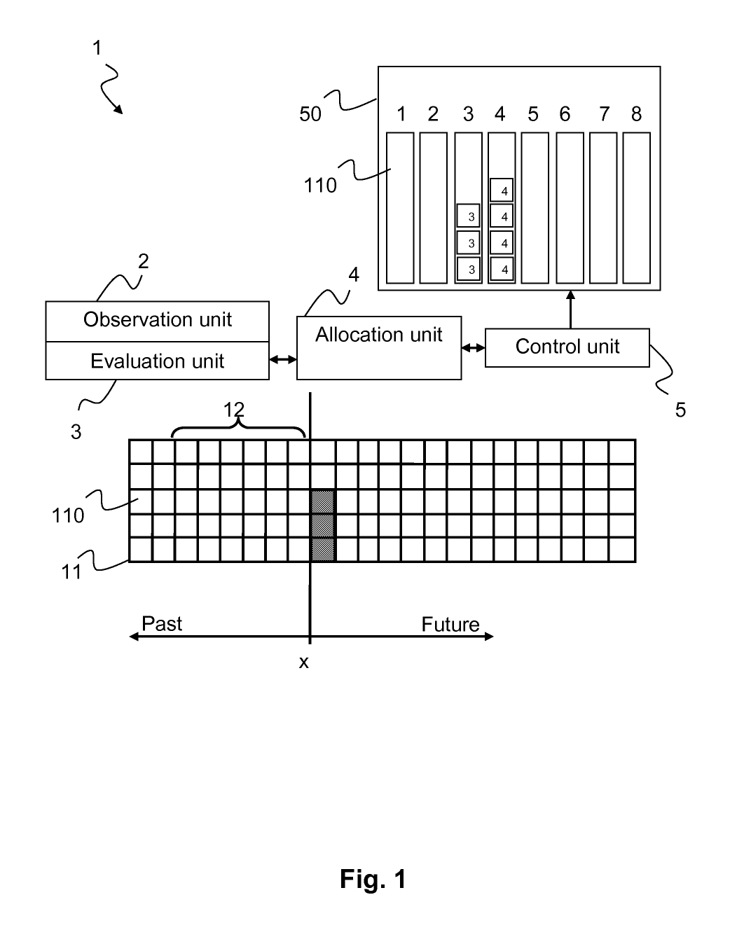

FIG. 1 shows a radio-transmission system 1 according to the invention. The radio-transmission system 1 comprises an observation unit 2 and an evaluation unit 3. In FIG. 1, observation unit 2 and evaluation unit 3 are illustrated within a single module. As an alternative, the observation unit 2 and the evaluation unit 3 are each provided as independent components in the radio-transmission system 1.

The observation unit 2 observes the channel loading 11 of the radio transmission system 1 over a pre-defined time period 12. The evaluation unit 3 evaluates the observed channel loading 11 of the observation unit 2. This evaluation is made available to an allocation unit 4. The allocation unit 4 allocates a sub-channel 110 to a data source 6, 7, 8 on the basis of the evaluated channel loading 11. The control unit 5 receives the allocation information from the allocation unit 4 and sets up a corresponding waiting schedule 50, (Channel Queue).

The channel queue 50 as shown in FIG. 1 provides eight sub-channels, wherein, at the moment, no data sources 6, 7, 8 are allocated to the sub-channels 1, 2, 5, 6, 7 and 8, so that these channels would therefore be available. By contrast, three data packets are allocated by the control unit 5 to sub-channel 3, which must be processed as soon as the sub-channel 3 allows a data transmission. Furthermore, four data packets are allocated by the control unit 5 to sub-channel 4. Sub-channels 3 and 4 are accordingly currently allocated to specific data sources 6, 7, 8.

Now, according to the invention, it is provided that the observation unit 2 observes the channel loading 11 for a pre-defined time period 12. As shown in the example in FIG. 1, this time period 12 is six transmission frames in a TDMA system. The number of timeframes which are to be used for the observation of the channel loading 11 is adjustable and dependent upon the respective system 1, the topology of the system, environmental influences and quality of service requirements.

As soon as the observation unit 2 has observed the channel loading 11 of the communications channel for the pre-defined time period 12, the evaluation unit 3 evaluates this observed channel loading 11. In particular, the number of free sub-channels 110, the number of allocated data sources 6, 7, 8 per time, the number of transmitted data packets and the total usage of the communications channel are evaluated. Further evaluations are possible and are not excluded by the idea of the invention. On the basis of this information, the future channel loading 11 is now determined within the framework of a heuristic analysis, before the data source 6, 7, 8 is allocated to a sub-channel 110.

According to the invention, a ratio of header data to payload data is accordingly improved. The observation unit 2 and the evaluation unit 3 are adjusted dependent upon the radio-transmission system 1 used, wherein, in particular, the type of multiple access, the sampling rate, the resolution, the quantisation and the observation time period 12 are used as parameters.

On the basis of the information collected and evaluated by the observation unit 2 and the evaluation unit 3, the radio-transmission system 1 can be analysed for the past and adapted for the future to the behaviour of the individual data sources 6, 7, 8 and the respective sub-channels 110. An adaptive and efficient channel allocation is made possible through the evaluation of the heuristic analysis. In this context, the heuristic analysis is application and usage dependent. Rules for the improvement of a channel allocation are accordingly specific and system dependent.

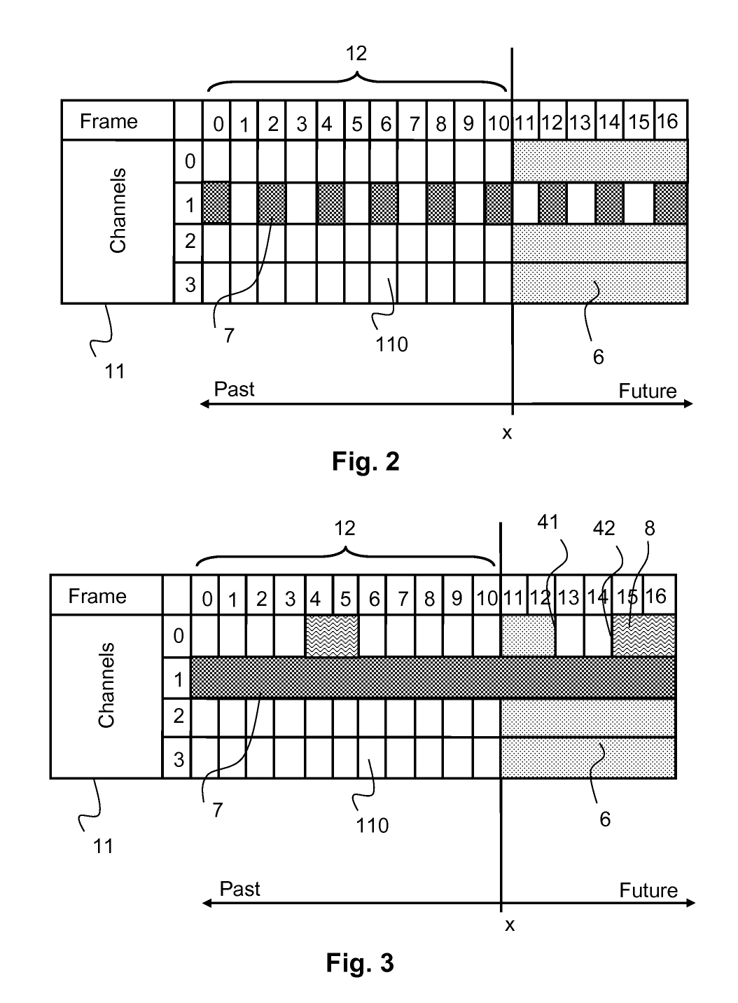

FIGS. 2 to 4 and 6 illustrate channel loadings 11 according to the invention of a communications channel according to a TDMA transmission method of the radio system 1 as shown in FIG. 1, which allow a more efficient future channel allocation. In this context, several data sources 6, 7, 8 on four exemplary sub-channels 110 are observed. Accordingly, the number of data sources 6, 7, 8 and the number of sub-channels 110 is not at all restricted.

In FIG. 2, a channel loading 11 according to the invention is provided from the time x. Four sub-channels 110, which are marked with 0, 1, 2 and 3 and of which the loading is shown over a duration of 17 frame periods, are shown. It is evident that the observation time period 12 amounts to 10 frame periods, so that the observation unit 2 observes the communications channel for at least 10 timeframes before an evaluation by means of the evaluation unit 3 takes place at time x. During this time period 12, the channel loading 11 is merely observed. At the evaluation time x, for the illustrated scenario shown in FIG. 2, the evaluation unit 3 evaluates that a data source 6, 7, 8 has never been allocated to the first, the third and the fourth sub-channel 110. A second data source 7 has been allocated to the second sub-channel 110. Corresponding to the past transmission behaviour of the second data source 7 and the number of already transmitted data in only every second frame, the evaluation unit 3 evaluates the channel loading at the time x in such a manner that a quasi-continuous data transmission takes place on the second sub-channel 110, which will also endure into the future.

The data packets of a first data source 6 are now to be transmitted within the system 1. In the case of the application for a free sub-channel 110 at the time x, all four sub-channels 110 are, by chance, available. Accordingly, the first data source 6 could be allocated to any of the four sub-channels 110. If the second sub-channel 110 were to be allocated to the first data source 6, the second data source 7 would have to give way with its datastream onto an alternative sub-channel 110. For this purpose, the second sub-channel 110 would have to be de-allocated and a sub-channel 110 different from the second sub-channel 110 would have to be allocated. This would lead to at least two additional header records, thereby worsening the header to payload ratio in an undesirable manner.

The observation unit 2 has now registered that data according to a quasi-continuous signal of the second data source 7 are transmitted via the second sub-channel 110. The evaluation unit 3 identifies this quasi-continuous transmission of the second data source 7 and prompts the allocation unit 4 not to make this second sub-channel 110 available for the first data source 6. The evaluation unit 3 accordingly indicates to the allocation unit 4 that the second sub-channel 110 should preferably not be used for the first data source 6. Correspondingly, only the first, third and fourth sub-channels are allocated to the first data source 6. This advantageously means that the datastream via the second data source 7 continues to be transmitted via the second sub-channel 110 and no additional header data need to be generated which would impair the efficiency of the channel capacity with regard to the transmission of payload data in an undesirable manner.

FIG. 3 shows an alternative channel loading 11 to that shown in FIG. 2. In a similar manner to FIG. 2, the channel loading 11 of the communications channel is observed within a pre-defined time period 12 of 10 frame times. It is evident that the first sub-channel 110 is constantly allocated to a second data source 7, and this sub-channel 110 should not be further allocated. Accordingly, from time x, this second sub-channel 110 should also not be available for other data sources 6, 8.

From time x, the first data source 6 has a large number of data packets to transmit, so that from the 11^{th} timeframe, all of the free sub-channels 110 are made available to the first data source 6. Because of the observation of the channel loading 11 by the observation unit 2, the evaluation unit 3 identifies that a third data source 8 transmits data packets at irregular intervals via the first sub-channel 110. With this knowledge, the evaluation unit 3 prompts the allocation unit 4 to release the first sub-channel 110 from the 13^{th} frame, which is implemented through the channel release 41. From the 15^{th} frame, this first sub-channel 110 is allocated to the third data source 8 for the transmission of data packets. The third and fourth sub-channel 110 continue to be allocated to their full extent to the first data source 6. Accordingly, only two sub-channels 110 are indeed available to the first data source 6 for data-packet transmission, however, the third data source 8 can continue, as accustomed, to transmit its data packets via the first sub-channel 110, so that header data and waiting times of the third data source 8 are avoided. This scenario is, in particular, very probable, if a first data source 6 uses all of the free sub-channels 110 for data-packet transmission. During the course of time, the probability that further data sources 7, 8 will request channel allocations 40 increases, which leads to an increased volume of header data and reduces the efficiency of the payload-data transmission. By means of the heuristic analysis according to the invention, a channel release 40 of one of the sub-channels 110 is brought about by way of precaution through the evaluation of the evaluation unit 3 by the allocation unit 4. A further data source 7, 8 can then use this released sub-channel 110 without hindrance. Accordingly, an increased header data packet volume is prevented.

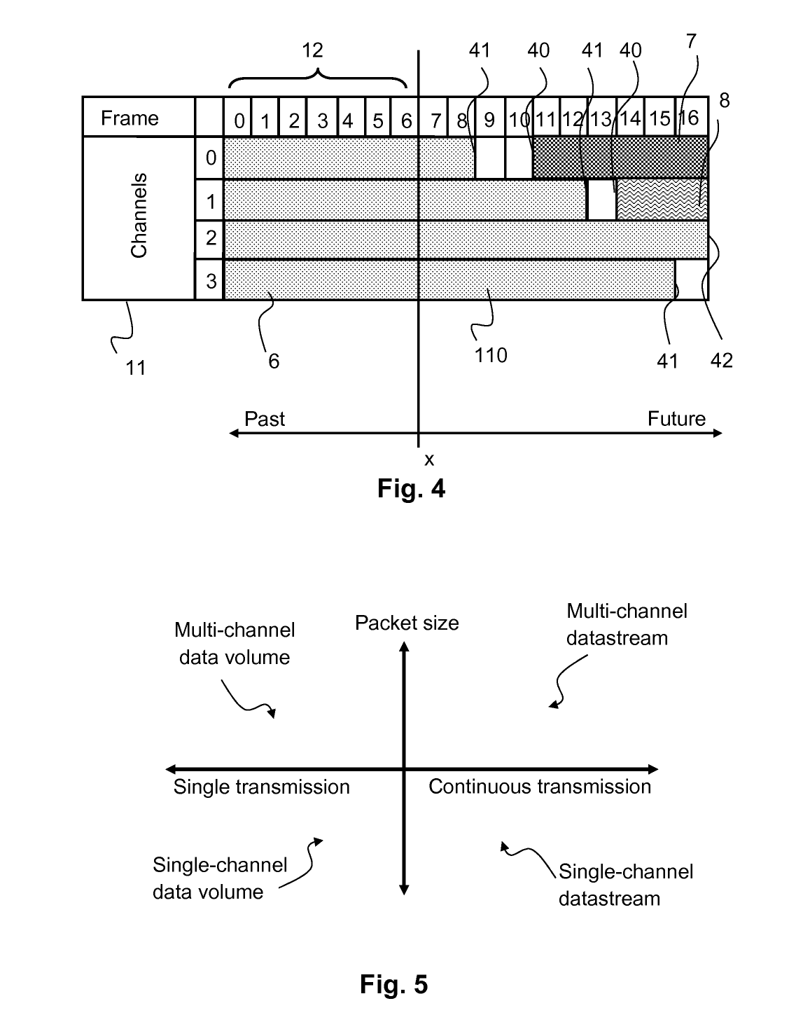

FIG. 4 shows an alternative channel loading 11 to those shown in FIGS. 2 and 3. In this context, the observation time period 12 is pre-defined to seven timeframe durations. The observation unit 2 identifies the loading of all of the sub-channels 110 by the first data source 6. Now, in order also to allow a transmission of data packets for a second data source 7, a reduction in the number of sub-channels for the first data source 6 is implemented successively. Accordingly, the first sub-channel 110 is released at the eighth frame. The channel release 41 leads to this first sub-channel 110 being allocated to the second data source 7 by the allocation unit 4 from the 11^{th} frame. The channel allocation 40 means that the second data source 7 can begin with the transmission of data even without having to wait for a complete transmission of the data packets by the first data source 6. Added to this, with an increasing frame number, the probability increases that several further data sources 7, 8 might apply for a data transmission, which would increase the header data rate.

A similar scenario takes place on the second sub-channel 110, wherein the time of the channel release takes place only from the 12^{th} frame. Accordingly, the data transmission can be adapted efficiently to the data volumes to be transmitted without additional header data being communicated.

Since the first data source 6 releases the first sub-channel 110, this first sub-channel 110 can be allocated to the second data source 7. In this manner, the second data source 7 need not wait until the 12^{th} data frame in order to start a transmission.

FIG. 5 shows a decision diagram according to the invention for the classification of a channel loading 11. According to FIG. 5, a distinction is made, in the case of a sub-channel loading, between data to be transmitted in a single transmission and a continuous datastream. A further decision criterion is the data packet size, so that small data packets or respectively a small number of data packets are distinguished from large data volumes. Dependent upon these decision criteria, the evaluation unit 3 prompts the allocation unit 4 to allocate one or more sub-channels 110.

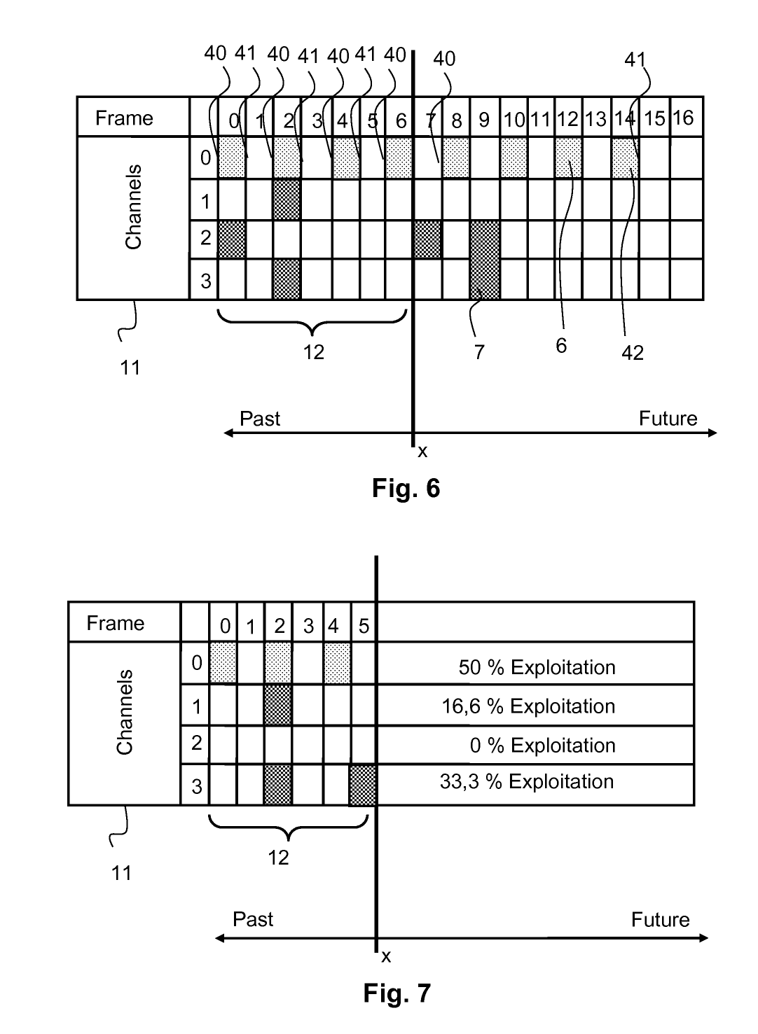

FIG. 6 shows an alternative channel loading 11 to those shown in FIGS. 2, 3 and 4. In this example, the observation time period 12 is pre-defined to seven timeframe durations. The observation unit 2 identifies a quasi-continuous data transmission of the first data source 6 on the first sub-channel 110. In this context, before the time x, every data packet of the first data source 6 is allocated to the first sub-channel 110 and released again after the transmission of the packet. This allocation 40 and release 41 of the sub-channel 110 for the first data source 6 immensely increases the header data rate and prevents an efficient exploitation of the channel capacity of the communications channel with regard to the payload-data transmission. Through the observation of the first sub-channel 110, the evaluation unit 3 evaluates the transmission as a quasi-continuous datastream.

Now, in order to prevent a constant allocation 40 and de-allocation 41, prompted by the evaluation unit 3, the allocation unit 4, allocates the first sub-channel 110 constantly to the first data source 6. Accordingly, the constant allocation 40 and de-allocation 41 for each data packet is dispensed with. The header data rate is accordingly reduced. The de-allocation 41 is prompted as soon as the first data source 41 indicates the end of the data transmission.

Furthermore, FIG. 6 shows a data transmission of the second data source 7 on the second, third and fourth sub-channels 110. Through observation and evaluation of the past, the allocation unit 4 is prompted by the evaluation unit 3, from time x, to keep the second sub-channel 110 free and to implement the transmission of the data of the second data source 7 only on the third and fourth sub-channel. In this manner, the first sub-channel 110 is kept free for other data sources 8 and can be used without a collision in the application which would lead to a high volume of header data.

FIG. 7 shows an evaluation result of the evaluation unit 3. In this context, the actual total exploitation of every sub-channel 110 is calculated for the last six time periods 12. These evaluations can now be used to identify free sub-channels 110, here, the third sub-channel 110, or the distribution of a data source 7 over several sub-channels 110, here, the second data source 7, over the first and fourth sub-channels 110 and can make this information available to the allocation unit 4.

Within the framework of the invention, all of the elements described and/or claimed and/or illustrated can be combined arbitrarily with one another. In particular, the identified and evaluated channel loadings 11 of the FIGS. 2, 3, 4, 6 and 7 can be combined with one another.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A radio-transmission system with multiple-channel access for the transmission of data packets of different data sources via a communications channel, comprising:
a channel observation unit configured for observation of the channel loading of the communications channel;
an evaluation unit configured for evaluation of the observed channel loading;
a channel allocation unit configured for allocation of a sub-channel to a data source on the basis of the evaluated channel loading; and
a channel control unit configured for time control of the sub-channel allocation.

2. The radio-transmission system according to claim 1,
wherein the observation unit is configured to observe the channel loading of the communications channel for at least one predefined time period, and
wherein an allocation of a data source to a sub-channel takes place only after the expiry of the predefined time period.

3. The radio-transmission system according to claim 1,
wherein the evaluation unit is configured to evaluate the observed channel loading with regard to potentially free sub-channels.

4. The radio-transmission system according to claim 1,
wherein the evaluation unit is configured to identify a quasi-continuous data transmission on one of the sub-channels, wherein this sub-channel is evaluated as loaded.

5. The radio-transmission system according to claim 1,
wherein the evaluation unit is configured to identify a data source with at least two already allocated sub-channels, and
wherein the allocation unit is prompted by the evaluation unit to release at least one of these allocated sub-channels to this data source.

6. The radio-transmission system according to claim 1,
wherein the evaluation unit is configured to identify at least two data sources with at least two already allocated sub-channels, and
wherein the allocation unit is prompted by the evaluation unit to release at least one of the allocated sub-channels, at least from one of the data sources.

7. The radio-transmission system according to claim 1,
wherein the evaluation unit is configured to identify the dedicated use of a sub-channel for a data source,
wherein this sub-channel is identified as loaded and need not be constantly reallocated by the allocation unit to this data source.

8. The radio-transmission system according to claim 1,
wherein the evaluation unit evaluates the number of data packets per data source.

9. The radio-transmission system according to claim 1,
wherein the evaluation unit evaluates the number of allocated sub-channels per data source per time.

10. The radio transmission system according to claim 1,
wherein the evaluation unit evaluates the total number of allocated sub-channels.

11. The radio-transmission system according to claim 1,
wherein the evaluation unit is matched to an existing topology and to the specific radio-transmission system.

12. The radio-transmission system according to claim 1,
wherein the radio-transmission system further comprises a collision management system and a prioritisation system.

13. A radio-transmission method with multiple-channel access for the transmission of data packets via a communications channel with the method steps:
observation of a channel loading of the communications channel;
evaluation of the observed channel loading;
allocation of a sub-channel dependent upon the evaluated channel loading; and
control of the channel loading on the basis of the allocated sub-channels.

14. The radio-transmission method according to claim 13,
wherein the method further comprises a collision management method and a prioritisation management method.
